(19) United States
(12) Patent Application Publication
(10) Pub. No.: US 2004/0139594 A1
(43) Pub. Date: Jul. 22, 2004

(54) Method for making a flexible cutting tool, and resulting cutting tool

(76) Inventors: Philippe Schrall, Muret (FR); Jean-Pierre Gelis, Empeaux (FR)

Correspondence Address: YOUNG & THOMPSON, 745 SOUTH 23RD STREET 2ND FLOOR, ARLINGTON, VA, 22202

(21) Appl. No.: 10/466,048

(22) PCT Filed: Jan. 15, 2002
(86) PCT No.: PCT/FR02/00135

(30) Foreign Application Priority Data
Jan. 15, 2001 (FR) 01/00458

(51) Int. Cl. B23B 11/00; B23P 11/00

(52) U.S. Cl. 29/557; 29/34 R; 29/428

(57) ABSTRACT

A method for making a flexible cutting tool comprising a wire-shaped flexible support (1) having a substantially constant circular cross-section, a plurality of rigid elements (2) integral with the wire-shaped flexible support (1), the plurality of rigid elements (2) including at least a front cutting edge (3) extending into the space (4) enclosing the wire-shaped flexible support. The plurality of rigid elements is obtained at least by winding and swaging, respectively a plurality of sections of metal strips around the flexible support. The invention also concerns a cutting tool obtained by the method in particular for cutting mud bricks, clay or the like.

The present invention relates to the field of flexible cutting tools comprising a wire-shaped flexible support which has a substantially constant circular cross-section, a plurality of rigid elements integral with said wire-shaped flexible support, said plurality of rigid elements including at least one front cutting edge extending into the space surrounding the wire-shaped flexible support, as well as to the method of manufacturing same.

Cutting tools of the abrasive wire type are known, obtained for example by dipping a metal wire of a predetermined length, generally short, in a receptacle containing abrasive elements which attach themselves to the surface of the wire. Such a manufacturing method limits the length of abrasive wire which can be obtained, in particular by the dimensions of the dipping receptacle, conferring to such abrasive wires a limited specific use, especially for alternating saws having a reduced cutting length. In addition, the abrasive wire obtained by dipping only permits total covering of the surface of the core of the wire, which can in certain cases lead to problems of evacuation of the removed material and of heating of the wire. Finally the cutting speed remains low and the cost of such an abrasive tool high.

Flexible cutting tools are also known comprising a plurality of rigid elements integral with the wire-shaped flexible support, these rigid elements including at least one front cutting edge extending into the space surrounding the wire-shaped flexible support. Such tools are described more particularly in the documents FR 1 378 362, FR 949 457, FR 2 019 598, U.S. Pat. No. 5,080,086, DE 197 52 223, U.S. Pat. No. 2,696,228, DE 35 27 841, DE 24 00 205, DE 43 06 273. However, all these tools are very expensive to manufacture, whilst being tools which wear and are intended to be renewed.

The present invention proposes a method of manufacturing a flexible cutting tool which makes it possible to overcome these disadvantages and to provide other advantages. More precisely, the invention relates to a method of manufacturing a flexible cutting tool comprising a wire-shaped flexible support which has a substantially constant circular cross-section, a plurality of rigid elements integral with said wire-shaped flexible support, said plurality of rigid elements including at least one front cutting edge extending into the space surrounding the wire-shaped flexible support, characterised in that said plurality of rigid elements is obtained at least by winding and swaging, respectively a plurality of sections of metal strips around said flexible support.

According to an advantageous feature, the method according to the invention consists in:

a) placing at least one metal strip at least partially around said wire-shaped flexible support, and cutting said at least one metal strip to the desired length depending on the diameter of said wire-shaped flexible support so as to form at least one metal strip section,

b) grinding at least one of the two ends of said at least one section,

c) completing the winding of said at least one metal strip section around said wire-shaped flexible support, such that the two ends are contiguous,

d) welding the said two ends of the said at least one section,

e) forming the said at least one cutting edge by means of a stamping tool simultaneously initiating the swaging of the at least one section on said wire-shaped flexible support,

f) hardening superficially said at least one cutting edge by heat treatment making it possible to obtain said at least one rigid element.

According to another feature, said step of forming said at least one cutting edge by means of a stamping tool is executed in a manner which is radial and concentric with said wire-shaped flexible support.

According to another feature, the method according to the invention consists in carrying out steps a) to f) successively by means of a follow-on tool by advancing said wire-shaped flexible support.

According to another feature, the method according to the invention consists in renewing the successive execution of steps a) to f) by means of a follow-on tool by advancing said wire-shaped flexible support and said metal strip, with a view to associating said plurality of rigid elements with said wire-shaped flexible support.

According to another feature, the method according to the invention consists in impressing a rotation on said wire-shaped flexible support during its forward motion so as to offset at an angle the said at least one cutting edge on two successive rigid elements.

According to another feature, the method according to the invention consists in forming at least two successive different cutting edges on two successive rigid elements, respectively, during step e).

According to another feature, the method according to the invention consists also in sharpening said at least one cutting edge after having hardened it superficially, so as to modify its profile.

According to another feature, the method according to the invention consists also in carrying out a surface treatment of said at least one cutting edge after having hardened it superficially, so as to increase its hardness and its resistance to wear.

The invention also relates to a flexible cutting tool comprising a wire-shaped flexible support which has a substantially constant circular cross-section, comprising a plurality of rigid elements integral with the wire-shaped flexible support, said plurality of rigid elements including at least one front cutting edge extending into the space surrounding the wire-shaped flexible support, characterised in that said tool is obtained by a method according to the invention.

The use of a front cutting edge makes it possible to cut the material instead of abrading it as is the case with abrasive wires. Thus each rigid element advantageously fixed in a rigid manner on the flexible support bears at least one front cutting edge making it possible to machine the material in the manner of a cutting tool. The rigid cutting element acts no longer via its lateral surface which rubs against the material to be cut but acts via its front face which has a cutting edge.

According to an advantageous feature, said cutting edge extends into the space surrounding the wire-shaped flexible support, on one of the rigid elements at least.

According to another feature, said rigid elements are arranged at a predetermined spacing along the flexible support.

According to another feature, said rigid elements adopt respectively a longitudinal external surface comprising a conical shape, said longitudinal external surface being delimited between a first and a second transverse end surface, said first end surface having a greater area than that of the second end surface, the projection of the second end surface along a longitudinal axis of the flexible support being inscribed in said first end surface, and in that said at least one cutting edge is constituted by the intersection line between the longitudinal external surface of the rigid element and the first end surface of the latter.

Such a shape of the rigid element is more especially adapted for cutting non-abrasive materials, for example materials which are encountered in the field of food-processing, such as frozen products.

According to another feature, two successive rigid elements are offset in an angular manner in a plane which is transverse with respect to the flexible support.

Thus the front cutting section can be spread over several rigid elements, one rigid element assuming only one portion of the cutting edge defining the front cutting section.

According to another feature, said wire-shaped flexible support is a single-strand cable.

According to another feature, said flexible support forms a loop.

Other features and advantages will appear in reading the following description of several examples of embodiment of a flexible cutting tool and of the manufacturing method according to the invention, accompanied by the annexed drawings, these examples being given by way of non-restrictive illustration.

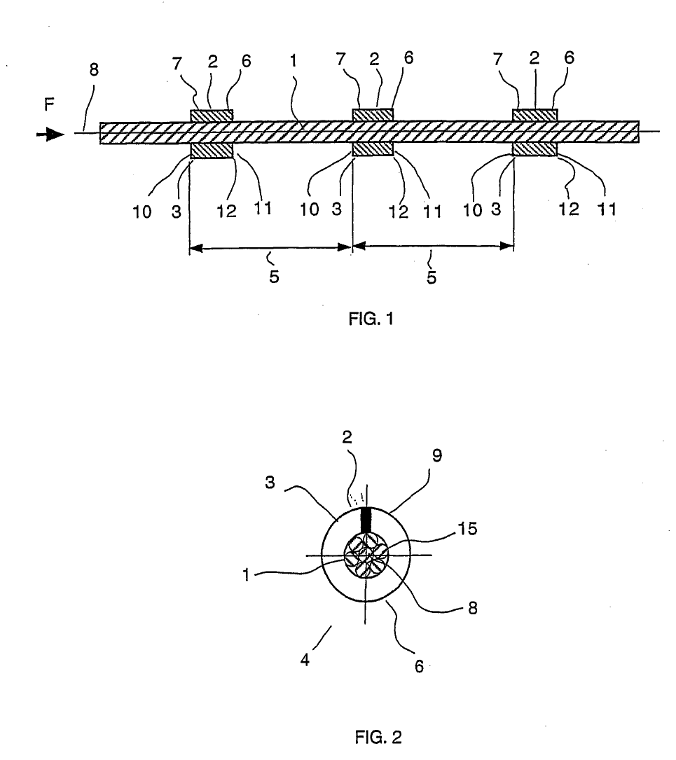

FIG. 1 is a diagrammatic longitudinal sectional view of a first example of an embodiment of a flexible cutting tool according to the invention.

FIG. 2 is an end view, in the direction F, of the example according to FIG. 1.

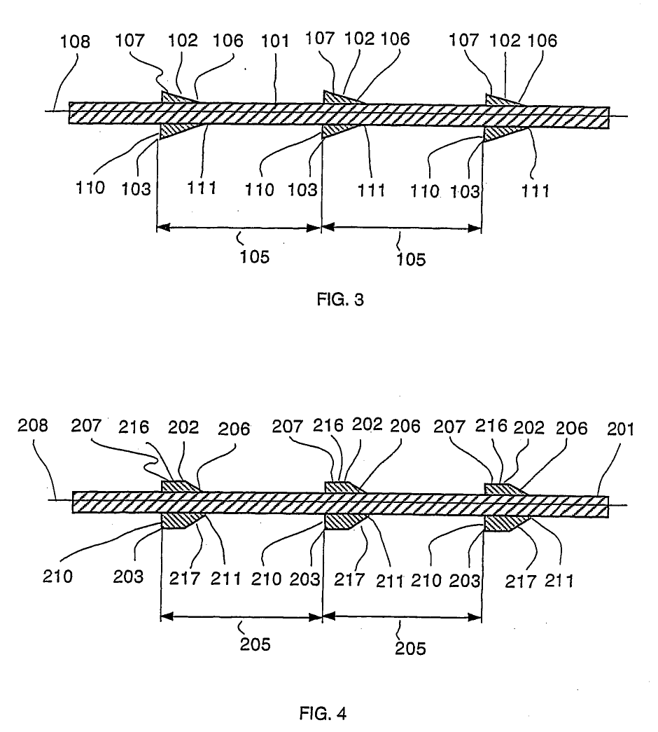

FIG. 3 is a diagrammatic longitudinal sectional view of a second example of an embodiment of a flexible cutting tool according to the invention.

FIG. 4 is a diagrammatic longitudinal sectional view of a third example of an embodiment of a flexible cutting tool according to the invention.

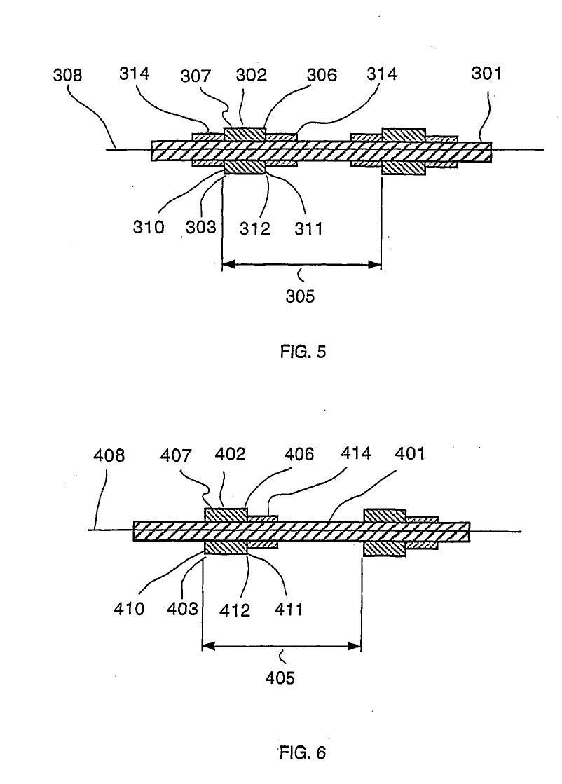

FIG. 5 is a diagrammatic longitudinal sectional view of a fourth example of an embodiment of a flexible cutting tool according to the invention.

FIG. 6 is a diagrammatic longitudinal sectional view of a fifth example of an embodiment of a flexible cutting tool according to the invention.

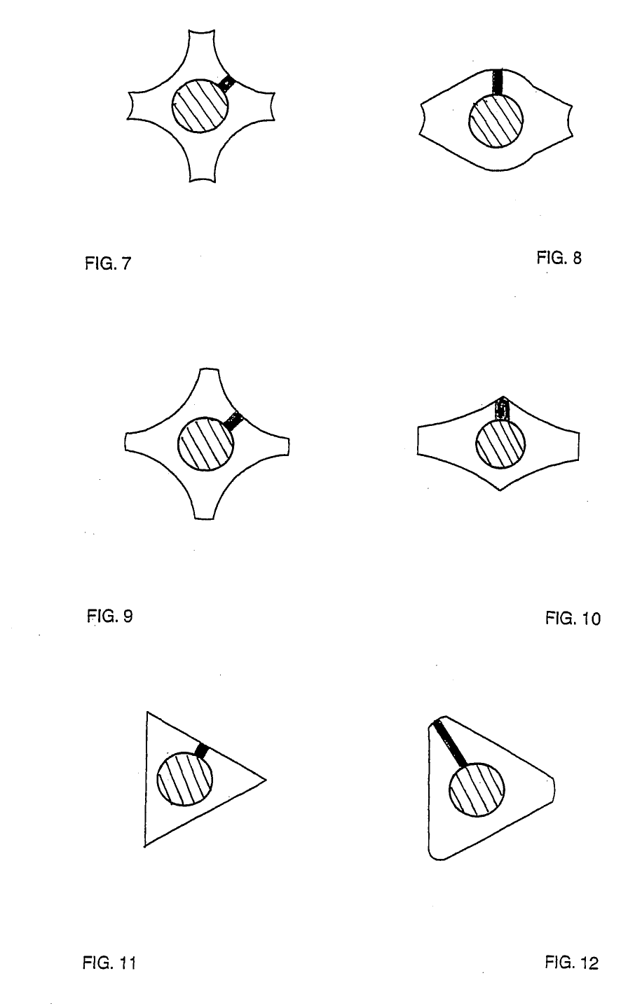

FIGS. 7 to 12 represent in an end view six examples of embodiments of a part of the cutting tool according to the invention.

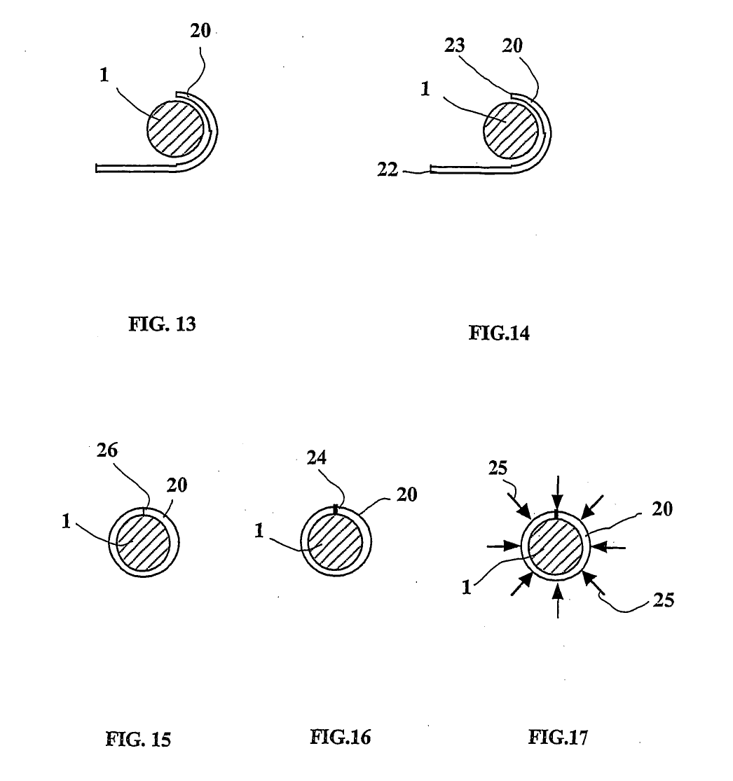

FIGS. 13 to 17 represent in a cross-sectional view, five steps in the manufacture of an example of an embodiment of a manufacturing method for a flexible cutting tool according to the invention.

The flexible cutting tool represented on FIGS. 1 and 2 comprises a wire-shaped flexible support 1, which has a substantially constant circular cross-section, a plurality of rigid elements 2 integral with the wire-shaped flexible support 1, including respectively a first 3 and a second 12 front cutting edge extending into the space 4 surrounding the wire-shaped flexible support.

The wire-shaped flexible support 1 can be formed from any flexible material, resisting in traction the cutting force which must be provided, for example a metal cable as represented, or a plaited rope formed from aramid fibres or the like. The material of the cable will have to be resistant to wear depending on the material cut. When the cut material is abrasive, for example brick or paper, the cable will preferably be a single-strand metal cable, less flexible than a multi-strand cable, but more resistant. The incidence of use of a single-strand cable resides principally in the minimum range of curvature of such a cable, which is greater than that of a multi-strand cable. When the cut material is not, or is less, abrasive, for example like frozen food products, the wire-shaped flexible support can be a multi-strand metal cable, thus permitting the use of driving pulleys which are smaller in diameter, and thus obtaining a cutting machine of a more reduced volume, down to that of a household apparatus for example.

The rigid elements 2 are realised in metal, for example in steel for a cutting tool capable of undergoing cold forming and obtained at least by winding and swaging, respectively a plurality of sections of metal strips around the flexible support 1. Each metal strip section from which a rigid element is formed, has a width which is smaller than or equal to the length of the rigid element and a length corresponding approximately to the circumference of the wire-shaped flexible support, then is wound and swaged around the latter, as explained later. The width of the strip section can in effect be determined taking into account the fact that during swaging there is a certain creep in the material. The rigid elements 2 can advantageously undergo heat treatment in order to increase their resistance to wear.

The rigid elements 2 are associated respectively with the wire-shaped flexible support 1 via a rigid total link, obtained by swaging. The rigid elements 2 are arranged along the flexible support 1 at a predetermined spacing 5, for example a variable spacing, or a constant spacing as represented on FIG. 1.

As represented on FIG. 1, the rigid elements 2 adopt for example respectively a longitudinal external surface 6 generated by a straight line 7 which is displaced parallel to a fixed direction 8 resting on a predetermined line 9, the longitudinal external surface being delimited between a first 10 and a second 11 transverse end surface, the first 3 and second 12 cutting edges being constituted respectively by the intersection lines between the longitudinal external surface 6 of the rigid element 2 and the first 10 and second 11 end surfaces of the latter. The first 3 and second 12 cutting edges are advantageously formed by means of a stamping tool simultaneously initiating the swaging of the metal strip section on the wire-shaped flexible support 1.

In the case of FIG. 1, the fixed direction is given by the longitudinal axis 8 of the flexible support, and the predetermined line 9 is a closed curved line, a circle 9 in this case, thus providing a rigid element 2 with the shape of a cylinder having a circular cross-section. The first 10 and second 11 end transverse surfaces are parallel to each other and perpendicular to the longitudinal axis 8 of the flexible support 1, such that a rigid element 2 adopts the form of a right cylinder. The cutting edges 3, 12, facing each other, permit the flexible tool to cut along the longitudinal axis 8 in one direction and the opposite direction, such that the flexible cutting tool can function to and fro or in continuous displacement in one direction. In the case of unidirectional displacement of the tool, a single end surface 10 or 11 ensures the role of cutting face and in the case of alternating bi-directional displacement of the tool, the two opposite end faces 10, 11 ensure alternately the function of the cutting face.

FIG. 3 represents a flexible cutting tool similar to that of FIG. 1, except for the rigid elements 102 which adopt a different shape. On FIG. 3, the elements similar to those of the cutting tool represented on FIG. 1 have been provided with the same numerical references with the addition of the number 100.

The rigid elements 102 adopt respectively a longitudinal external surface 106 comprising a conical shape, the longitudinal external surface 106 being delimited between a first 110 and a second 111 transverse end surface, the first end surface 110 having an area greater than that of the second end surface 111, the projection of the second end surface 111 along a longitudinal axis 108 of the flexible support 101 being inscribed in the first end surface 110, the cutting edge 103 being constituted by the intersection line between the longitudinal external surface 106 of the rigid element 102 and the first end surface 110 of the latter.

On FIG. 3, elements 102 are like flattened cones, the external shape of which is inscribed in right cones respectively, the second end surface being substantially equal to the cross-section of the flexible support 102, as represented.

FIG. 4 represents a flexible cutting tool similar to that of FIG. 1 or 3, except for the rigid elements 202 which adopt a different shape. On FIG. 4, the elements similar to those of the cutting tool represented on FIG. 1 have been provided with the same numerical references with the addition of the number 200.

The rigid elements 202 adopt respectively a longitudinal external surface 206 comprising a conical shape, the longitudinal external surface 206 being delimited between a first 210 and a second 211 end transverse surface, the first end surface 210 having an area greater than that of the second end surface 111, the projection of the second end surface 211 along a longitudinal axis 208 of the flexible support 201 being inscribed in the first end surface 210, the cutting edge 203 being constituted by the intersection line between the longitudinal external surface 106 of the rigid element 102 and the first 110 end surface of the latter.

On FIG. 4, the rigid elements 202 adopt respectively the shape of a cylindrical portion 216 of circular cross-section followed in the axis 208 of the support 201 by a conical portion 216, the base section of which corresponds to the cross-section of the cylindrical portion 216 and the section opposite the base section corresponds to the cross-section of the support 201.

FIG. 5 represents a flexible cutting tool similar to that of FIG. 1, except for the rigid elements 302 which adopt a different shape and/or a different method of fixing to the support. On FIG. 5 the elements similar to those of the cutting tool represented on FIG. 1 have been provided with the same numerical references with the addition of the number 300.

The rigid elements 302 are manufactured from metal sheets wound and swaged on the support 301, the metal sheets comprising for example respectively two opposite shoulders 303, 312 in such a way as to form a stepped section such as represented on FIG. 5, or on FIG. 6 for which the metal sheets comprise a single shoulder.

On FIG. 5, the cutting is carried out by the central portion of the metal sheet, the diameter of which is the greatest, the two cutting edges 303 and 312 being constituted by the two shoulders respectively. The lateral portions 314 can be used to reinforce the swaging of the rigid element 302 on the support 301.

FIG. 6 represents a flexible cutting tool similar to that of FIG. 5, except for the rigid elements 402 which adopt a different shape. On FIG. 6, the elements similar to those of the cutting tool represented on FIG. 5 have been provided with the same numerical references with the addition of the number 100. On FIG. 6, unlike FIG. 5, a single lateral portion 414 is joined to the central portion of the rigid element 402, which is also obtained from a metal sheet or strip. The rigid element 402 includes two cutting edges 403 and 412 in order to cut in the two opposite directions of displacement of the support.

As represented on FIGS. 7 to 12, the rigid elements can adopt various cross-sections, which can be identical or different on the same support. Furthermore, two successive rigid elements can be offset in an angular manner in a plane which is transverse with respect to the flexible support, such that the peripheral line of the cutting section can be provided by a plurality of rigid elements and not a single one.

On FIGS. 7 to 12, the examples of rigid elements represented adopt respectively a longitudinal external surface (not represented on the figures) generated by a straight line which is displaced parallel to a fixed direction resting on a predetermined line, the longitudinal external surface being delimited between a first and a second transverse end surface, and the cutting edge or edges being constituted by the intersection line between the longitudinal external surface of the rigid element and at least the first end surface of the latter represented in end view on FIGS. 7 to 12. The contour represented on each FIGS. 7 to 12 illustrates this intersection line which constitutes the cutting edge.

On FIGS. 7, 8, 9, 10, 11 and 12, the fixed direction is given by the longitudinal axis of the flexible support and the predetermined line is a closed dotted line.

On FIGS. 7, 8, 9, 10 and 12, the closed dotted line includes one or more curved portions, notably arcs of circles.

On FIGS. 7 to 12, the linking by welding of the two ends of a section of metal strip forming a rigid element has been represented as a darkened area.

The flexible cutting tool according to the invention will be manufactured in the following manner: steel strip in a ring according to the desired profile, from which the rigid cutting elements will be formed, and a cable in a ring, acting as a flexible support for the rigid elements, will be disposed on an appropriate supporting member, as described below; the steel strip will be cut into identical metal strip sections of a predetermined length corresponding substantially to the circumference of the cable, which strips will then be rolled around the cable and swaged at a defined spacing. An example of such a method of manufacturing a cutting tool, as represented for example on FIG. 1, will now be described in detail with the support of FIGS. 13 to 17.

The following method example is advantageously executed on a press with multiple slides, of the “Bihler” type for example, according to the technology of follow-on tools. The method consists in:

a) placing a metal strip 20 partially around the wire-shaped flexible support 1, for example as represented on FIG. 13, so as to leave the free end 23 of the strip detached, and cutting the metal strip to the desired length depending on the diameter of the wire-shaped flexible support, so as to leave free the other end 22 of the strip formed by the cutting, so as to form at least one section 21 of metal strip capable of surrounding in its entirety the circumference of the flexible support 1,

b) grinding the two ends 22, 23 of the section 21, as represented in FIG. 14, by means of appropriate grinding wheels (not represented) depending on the weld seam to be realised, so as to prepare these ends for said welding in accordance with step d),

c) completing the winding of the metal strip section 21 around the wire-shaped flexible support such that the two ends 22, 23 are contiguous, as represented on FIG. 15, this step being realised by means of appropriate closing dies (not represented), the junction of the ends being represented by the reference 26,

d) welding the two ends of section 21, as represented on FIG. 16, for example by brazing 24; the welding method should be compatible with the material constituting the flexible support,

e) forming the cutting edges 3, 12 by means of a stamping tool simultaneously initiating the swaging of section 21 on the wire-shaped flexible support 1, as represented on FIG. 17, the shape of the stamping tool defining the longitudinal external surface of the rigid element, for example cylindrical with a circular cross-section on the example represented,

f) superficially hardening the two cutting edges 3, 12 by a heat treatment making it possible to obtain a rigid element.

The step of forming the cutting edges 3, 12 by means of a stamping tool is advantageously carried out in a manner which is radial and concentric with the wire-shaped flexible support 1, as arrows 25 on FIG. 17 show.

Steps a) to f) can be carried out successively by means of follow-on tools by advancing the wire-shaped flexible support and the metal strip section in the course of linking with the flexible support. The successive execution of steps a) to f) is renewed by means of said follow-on tools by advancing the wire-shaped flexible support and the metal strip, with a view to associating the plurality of rigid elements 2 with the wire-shaped flexible support 1.

In an alternative manner, it is possible to impress a rotation on the wire-shaped flexible support 1 during its forward motion so as to offset at an angle the cutting edges of two successive rigid elements.

It is possible to form at least two successive different cutting edges on two successive rigid elements, respectively, during step e) described above, by using two different stamping tools acting alternately.

Furthermore, the method according to the invention can advantageously consist in sharpening a cutting edge after having hardened it superficially, after step f), in order to modify its profile or a cutting angle. This operation is advantageously realised by means of grinding wheels which can be mounted on a supplementary slide of the press with multiple slides.

Furthermore, the method according to the invention can advantageously consist in carrying out surface treatment of the cutting edge after having hardened it superficially, after step f), in order to increase its hardness and its resistance to wear.

By way of example, a flexible cutting wire intended to be used for cutting mud brick, clay or the like can adopt the following configuration:

ensuring the function of the flexible support, a single-strand metal cable with seven wires of 0.3 mm in diameter, defining an overall outside cable diameter of approximately 1 mm,

ensuring the cutting function, a plurality of rigid elements which, once realised, each have a circular cross-section with an outside diameter equal to 2 mm, a length equal to 2 mm, are arranged according to a constant spacing of 4 mm on the cable, formed of steel which has been heat treated, and are swaged on the cable. The steel strip from which the rigid elements are realised can have a thickness of 0.5 mm in order to define rings of 2 mm in diameter, a thickness going to 0.2 mm in the case of a shoulder for the lateral portions.

When steel is used, the rigid elements alone can advantageously undergo heat treatment, for example induction hardening, after being assembled with the cable.

The flexible cutting tool can undergo surface treatment aimed at protecting it and improving its resistance, for example electroplating such as with silicon oxide.

The ends of the cutting tool thus obtained, via the ends of the cable, will be preferably associated, in any known manner, in order to form a loop thanks to the loop thus formed by the cable. The loop-shaped cutting tool will be used on any appropriate machine between two pulleys, one of which will be a driving pulley, in the manner of a cable stretched between two pulleys.

According to requirements, the machine will permit, either by the displacement of the cutting tool, or by the displacement of the support of the material to be cut, a cut along a plane or along any profile generated by a generator constituted by the cutting axis defined by the support cable. Such a machine is described for example in the French patent application FR 9604641.

1. Method of manufacturing a flexible cutting tool comprising a wire-shaped flexible support (1) which has a substantially constant circular cross-section, a plurality of rigid elements (2) integral with said wire-shaped flexible support (1), said plurality of rigid elements (2) including at least one front cutting edge (3) extending into the space (4) surrounding the wire-shaped flexible support, characterised in that said plurality of rigid elements is obtained by winding and swaging, respectively a plurality of sections of metal strips around said flexible support.

2. Method according to claim 1, characterised in that it consists in:
a) placing at least one metal strip at least partially around said wire-shaped flexible support (1), and cutting said at least one metal strip to the desired length depending on the diameter of said wire-shaped flexible support so as to form at least one metal strip section,
b) grinding at least one of the two ends of said at least one section,
c) completing the winding of said at least one metal strip section around said wire-shaped flexible support (1), such that the two ends are contiguous,
d) welding the said two ends of the said at least one section,
e) forming the said at least one cutting edge by means of a stamping tool simultaneously initiating the swaging of the at least one section on said wire-shaped flexible support,
f) hardening superficially said at least one cutting edge by heat treatment making it possible to obtain said at least one rigid element.

3. Method according to claim 2, characterised in that said step of forming said at least one cutting edge by means of a stamping tool is executed in a manner which is radial and concentric with said wire-shaped flexible support.

4. Method according to claim 2 or 3, characterised in that it consists in carrying out steps a) to f) successively by means of a follow-on tool by advancing said wire-shaped flexible support.

5. Method according to claim 4, characterised in that it consists in renewing the successive execution of steps a) to f) by means of a follow-on tool by advancing said wire-shaped flexible support and said metal strip, with a view to associating said plurality of rigid elements with said wire-shaped flexible support.

6. Method according to claim 5, characterised in that it consists in impressing a rotation on said wire-shaped flexible support during its forward motion so as to offset at an angle the said at least one cutting edge on two successive rigid elements.

7. Method according to any one of claims 4 to 6, characterised in that it consists in forming at least two successive different cutting edges on two successive rigid elements, respectively, during step e).

8. Method according to any one of claims 2 to 7, characterised in that it consists also in sharpening said at least one cutting edge after having hardened it superficially, so as to modify its profile.

9. Method according to any one of claims 2 to 8, characterised in that it also consists in carrying out a surface treatment of said at least one cutting edge after having hardened it superficially, so as to increase its hardness and resistance to wear.

10. Flexible cutting tool comprising a wire-shaped flexible support (1) which has a substantially constant circular cross-section, comprising a plurality of rigid elements (2) integral with the wire-shaped flexible support (1), said plurality of rigid elements (2) comprising at least one front cutting edge (3) extending into the space (4) surrounding the wire-shaped flexible support, characterised in that said tool is obtained by a method according to one of claims 1 to 7.

11. Flexible cutting tool according to claim 10, characterised in that said cutting edge extends into the space (4) surrounding the wire-shaped flexible support, on one of the rigid elements at least.

12. Flexible cutting tool according to claim 10 or 11, characterised in that said rigid elements are arranged at a predetermined spacing (5) along the flexible support (1).

13. Flexible cutting tool according to any one of claims 10 to 12, characterised in that said rigid elements (102) adopt respectively a longitudinal external surface (106) comprising a conical shape, said longitudinal external surface being delimited between a first (110) and a second (111) transverse end surface, said first end surface having a greater area than that of the second end surface, the projection of the second end surface along a longitudinal axis of the flexible support being inscribed in said first end surface, and in that said at least one cutting edge (103) is constituted by the intersection line between the longitudinal external surface (106) of the rigid element (102) and the first (110) end surface of the latter.

14. Flexible cutting tool according to any one of claims 10 to 13, characterised in that two successive rigid elements are offset in an angular manner in a plane which is transverse with respect to the flexible support.

15. Flexible cutting tool according to any one of claims 10 to 14, characterised in that said wire-shaped flexible support is a single-strand cable.

16. Flexible cutting tool according to any one of claims 10 to 15, characterised in that said flexible support forms a loop.

17. Use of a cutting tool according to any one of the preceding claims for cutting mud bricks, clay or the like.
